(19) United States
(12) Patent Application Publication
(10) Pub. No.: US 2021/0165675 A1
(43) Pub. Date: Jun. 3, 2021

(54) LIVE MIGRATION FOR HARDWARE ACCELERATED PARA-VIRTUALIZED IO DEVICE

(71) Applicants: Xiao Wang, Shanghai (CN); Cunming Liang, Shanghai (CN); Tiwei Bie, Shanghai (CN); Zhihong Wang, Shanghai (CN)

(72) Inventors: Xiao Wang, Shanghai (CN); Cunming Liang, Shanghai (CN); Tiwei Bie, Shanghai (CN); Zhihong Wang, Shanghai (CN)

(21) Appl. No.: 16/717,889

(22) Filed: Dec. 17, 2019

Related U.S. Application Data
(60) Provisional application No. 62/942,732, filed on Dec. 2, 2019.

(51) Int. Cl. G06F 9/455; G06F 11/34

(52) U.S. Cl. CPC G06F 9/45558; G06F 11/3476; G06F 2009/4557; G06F 2009/45595; G06F 2009/45579

(57) ABSTRACT

Methods and apparatus for live migration for hardware accelerated para-virtualized IO devices. In one aspect, a method is implemented on a host platform including a VMM or hypervisor hosting a VM with a guest OS and a hardware (HW) input/output (TO) device implemented as a para-virtualized IO device with hardware acceleration that is enabled to directly write data into guest memory using a direct memory access (DMA) data path via a HW accelerator. A relayed data path including a software (SW) relay is setup between the HW IO device and a guest IO device driver. During a live migration of the VM, the SW relay tracks memory pages in guest memory being written to by the HW IO device via the DMA data path and logs the memory pages being written to as dirty memory pages. Embodiments may employ Vhost Data Path Acceleration (VDPA) for virtio, as well as other para-virtualization components.

### CROSS REFERENCE TO RELATED APPLICATION

The present application claims priority to U.S. Provisional Application No. 62/942,732 filed on Dec. 2, 2019, entitled “SOFTWARE-ASSISTED LIVE MIGRATION FOR HARDWARE ACCELERATED PARA-VIRTUALIZED IO DEVICE,” the disclosure of which is hereby incorporated herein by reference in its entirety for all purposes.

### BACKGROUND

There has been tremendous growth in the usage of so-called “cloud-hosted” services. Examples of such services include e-mail services provided by Microsoft (Hotmail/Outlook online), Google (Gmail) and Yahoo (Yahoo mail), productivity applications such as Microsoft Office 365 and Google Docs, and Web service platforms such as Amazon Web Services (AWS) and Elastic Compute Cloud (EC2) and Microsoft Azure. Cloud-hosted services are typically implemented using data centers that have a very large number of compute resources, implemented in racks of various types of servers, such as blade servers filled with server blades and/or modules and other types of server configurations (e.g., 1U, 2U, and 4U servers).

In recent years, virtualization of computer systems has also seen rapid growth, particularly in server deployments and data centers. Under one approach, a server runs a single instance of an operating system directly on physical hardware resources, such as the CPU, RAM, storage devices (e.g., hard disk), network controllers, input-output (IO) ports, etc. Under one virtualized approach using Virtual Machines (VMs), the physical hardware resources are employed to support corresponding instances of virtual resources, such that multiple VMs may run on the server's physical hardware resources, wherein each virtual machine includes its own CPU allocation, memory allocation, storage devices, network controllers, IO ports etc. Multiple instances of the same or different operating systems then run on the multiple VMs. Moreover, through use of a virtual machine manager (VMM) or “hypervisor,” the virtual resources can be dynamically allocated while the server is running, enabling VM instances to be added, shut down, or repurposed without requiring the server to be shut down. For example, hypervisors and VMMs are computer software, firmware, or hardware that are used to host VMs by virtualizing the platform's hardware resources under which each VM is allocated virtual hardware resources representing a portion of the physical hardware resources (such as memory, storage, and processor resources). This provides greater flexibility for server utilization, and better use of server processing resources, especially for multi-core processors and/or multi-processor servers.

Under another virtualization approach, container-based OS virtualization is used that employs virtualized “containers” without use of a VMM or hypervisor. Containers, which are a type of software construct, can share access to an operating system kernel without using VMs. Instead of hosting separate instances of operating systems on respective VMs, container-based OS virtualization shares a single OS kernel across multiple containers, with separate instances of system and software libraries for each container. As with VMs, there are also virtual resources allocated to each container.

Deployment of Software Defined Networking (SDN) and Network Function Virtualization (NFV) has also seen rapid growth. Under SDN, the system that makes decisions about where traffic is sent (the control plane) is decoupled for the underlying system that forwards traffic to the selected destination (the data plane). SDN concepts may be employed to facilitate network virtualization, enabling service providers to manage various aspects of their network services via software applications and APIs (Application Program Interfaces). Under NFV, by virtualizing network functions as software applications, network service providers can gain flexibility in network configuration, enabling significant benefits including optimization of available bandwidth, cost savings, and faster time to market for new services.

NFV decouples software (SW) from the hardware (HW) platform. By virtualizing hardware functionality, it becomes possible to run various network functions on standard servers, rather than purpose built HW platform. Under NFV, software-based network functions run on top of a physical network input/output (TO) interface, such as by NIC (Network Interface Controller), using hardware functions that are virtualized using a virtualization layer (e.g., a Type1 or Type 2 hypervisor or a container virtualization layer).

Para-virtualization (PV) is a virtualization technique introduced by the Xen Project team and later adopted by other virtualization solutions. PV works differently than full virtualization—rather than emulate the platform hardware in a manner that requires no changes to the guest operating system (OS), PV requires modification of the guest OS to enable direct communication with the hypervisor or VMM. PV also does not require virtualization extensions from the host CPU and thus enables virtualization on hardware architectures that do not support hardware-assisted virtualization. PV IO devices (such as virtio, vmxnet3, netvsc) have become the de facto standard of virtual devices for VMs running on Linux hosts. Since PV IO devices are software-oriented devices, they are friendly to cloud criteria like live migration.

Live migration of a VM refers to migration of the VM while the guest OS and its applications are running. This is opposed to static migration under which the guest OS and applications are stopped, the VM is migrated to a new host platform, and the OS and applications are resumed. Live migration is preferred to static migration since services provided via execution of the applications can be continued during the migration.

While PV IO devices are cloud-ready, their IO performance is poor relative to solutions supporting IO hardware pass-through VFs (virtual functions), such as single-root input/output virtualization (SR-IOV). However, pass-through methods such as SR-IOV have a few drawbacks. For example, when performing live migration, the hypervisor/VMM is not aware of device stats that are passed through to the VM and transparent to the hypervisor/VMM. Hence, the NIC hardware design must take live migration into account.

Another way to address the PV IO performance issue is using PV acceleration (PVA) technology, such as Vhost Data Path Acceleration (VDPA) for virtio, which supports hardware-direct TO within a para-virtualization device model. However, this approach also presents challenged for supporting live migration in cloud environments.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a block diagram illustrating selective components of a VDPA architecture;

FIG. 2 is a schematic diagram illustrating dirty page tracking by hardware and software under a current architecture implementing VDPA direct IO mode on the left and an architecture for dirty page tracking in accordance with one embodiment of software-assisted live migration for hardware accelerated para-virtualized IO devices on the right;

FIG. 3 is a diagram showing the descriptor ring, available ring, and used ring of a virtio ring;

FIG. 4 is a schematic diagram illustrating further details of an architecture for software-assisted live migration for hardware accelerated para-virtualized IO devices, according to one embodiment;

FIG. 5 is a flowchart illustrating the basic workflow for VDPA SW-assisted live migration of a running VM, according to one embodiment;

FIG. 6 is a schematic diagram illustrating an implementation of an event driven relay configured to track dirty pages, according to one embodiment;

FIG. 7 is a is a schematic diagram of a platform architecture configured to implement the software architecture shown in FIG. 4 using a System on a Chip (SoC) connected to a NIC, according to one embodiment; and

FIG. 7a is a schematic diagram of a platform architecture similar to that shown in FIG. 7 in which the NIC is integrated in the SoC.

### DETAILED DESCRIPTION

Embodiments of methods and apparatus for live migration for hardware accelerated para-virtualized IO devices are described herein. In the following description, numerous specific details are set forth (such as virtio VDPA IO) to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

Two elements (among others) that are implemented to support live migration are tracking and migration of device states and dirty page tracking. Device states is straight forward and addressed by PV, as PV implementations emulate the device states, which is software-based. In contrast, dirty page tracking, which tracks what memory pages are written to (aka dirtied) presents a challenge, as current hardware performs the direct IO DMA (Direct Memory Access) using the processor IOMMU (TO memory management unit) by PVA. In particular, current VDPA implementations do not implement a HW IO dirty page tracking mechanism that adequately supports live migration in cloud environments.

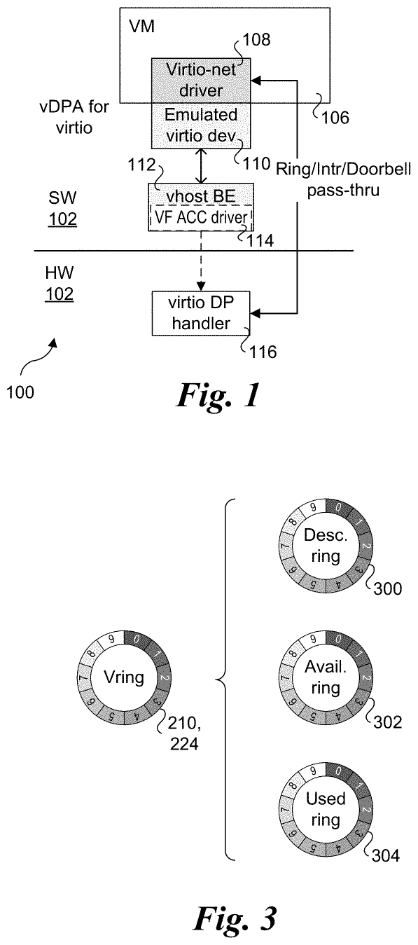

To have a better understanding of how the embodiments described herein may be implemented, a brief overview of VDPA is provide with reference to VDPA architecture 100 in FIG. 1. The VDPA architecture includes software components in a software layer 102 and a hardware layer 104 representing platform hardware. Software layer 102 includes a VM 106 including a virtio-net driver 108, an emulated virtio device 110, a vhost backend (BE) 112, and a VF acceleration driver 114. A virtio DP (data plane) handler 116 is implemented in hardware (e.g., a NIC, network interface, or network adaptor) in hardware layer 104. During operation, communication is exchanged between virtio DP handler 116 and virtio-net driver 108.

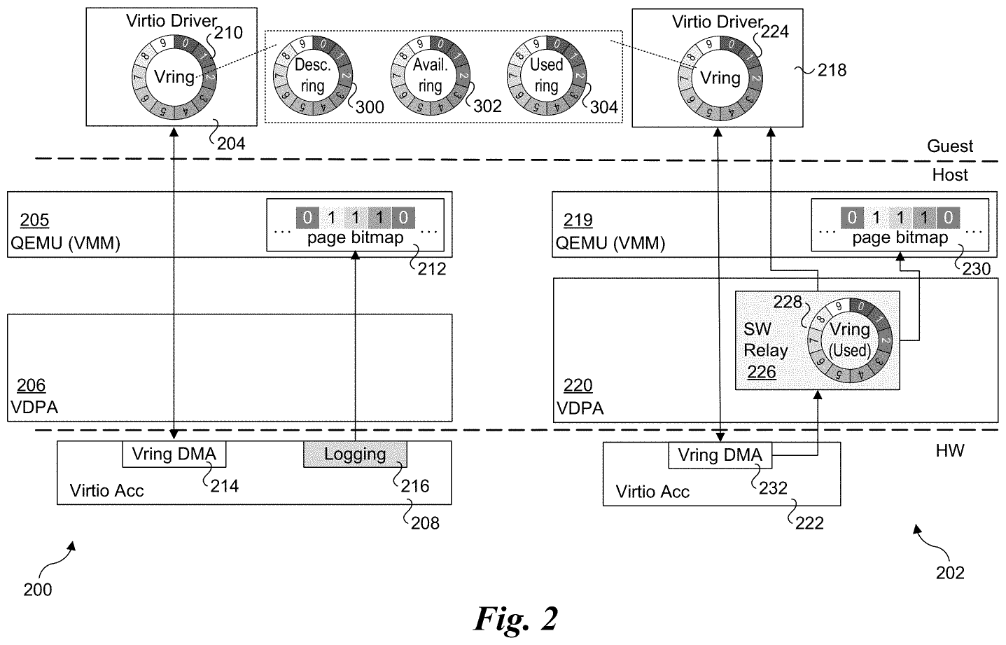

FIG. 2 shows dirty page tracking by hardware and software under a current architecture 200 implementing VDPA direct IO mode on the left and an architecture 202 for dirty page tracking in accordance with one embodiment of software-assisted live migration for hardware accelerated para-virtualized IO devices on the right.

Each of architectures 200 and 202 are logically partitioned into a Guest layer, a Host layer, and a HW layer. Architecture 200 includes a guest virtio driver 204 in the Guest layer, a QEMU block 205 and VDPA block 206 in the Host layer, and a virtio component such as a virtio accelerator 208 in the HW layer. Guest virtio driver 204 includes a virtio ring (vring) 210, while QEMU/VDPA block 206 includes a dirty page bitmap 212 and virtio accelerator 208 includes a vring DMA block 214 and a logging block 216.

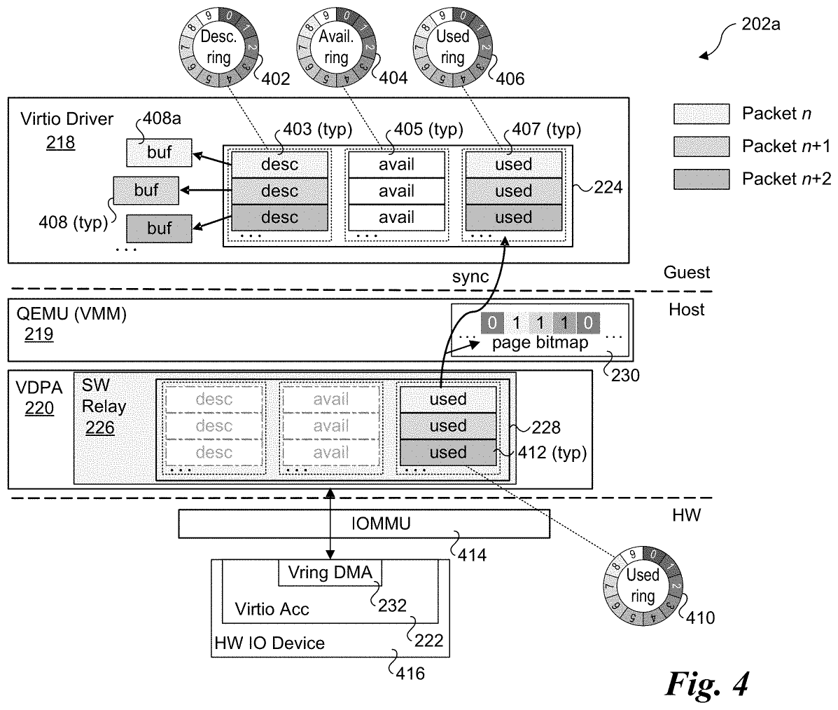

As shown in FIG. 3, virtio ring 210 and 224 (see below) are composed of a descriptor ring 300, an available ring 302 and used ring 304. Descriptor ring 300 is used to store descriptors that describe associated memory buffers (e.g., memory address and size). Available ring 302 is updated by the virtio driver to allocate tasks to the hardware IO device. Used ring 304 is updated by the hardware IO device to report to the virtio driver that a certain task is completed. Each of descriptor ring 300, an available ring 302 and used ring 304 are implemented as data structures in memory that are a form of circular buffers, aka “ring” buffers or “rings” under virtio for short. Descriptor ring 300 is used to store descriptors relating to DMA transactions. Available ring 302 and used ring 304 are implemented to support in order completion and provide completion notifications.

The following two paragraphs describe normal virtio operations relating to the use of the available ring and used ring. As described below, embodiments herein augment the normal virtio operations via use of a relayed data path including an intermediate relay component and an intermediate ring including a used ring.

To send data to a virtio device, the guest fills a buffer in memory, and adds that buffer to a buffers array in a virtual queue descriptor. Then, the index of the buffer is written to the next available position in the available ring, and an available index field is incremented. Finally, the guest writes the index of the virtual queue to a queue notify IO register, in order to notify the device that the queue has been updated. Once the buffer has been processed, the device will add the buffer index to the used ring, and will increment the used index field. If interrupts are enabled, the device will also set the low bit of the ISR Status IO register, and will trigger an interrupt.

To receive data from a virtio device, the guest adds an empty buffer to the buffers array (with the Write-Only flag set), and adds the index of the buffer to the available ring, increments an available index field, and writes the virtual queue index to the queue notify IO register. When the buffer has been filled, the device will write the buffer index to the used ring and increment the used index. If interrupts are enabled, the device will set the low bit of the ISR Status field, and trigger an interrupt. Once a buffer has been placed in the used ring, it may be added back to the available ring, or discarded.

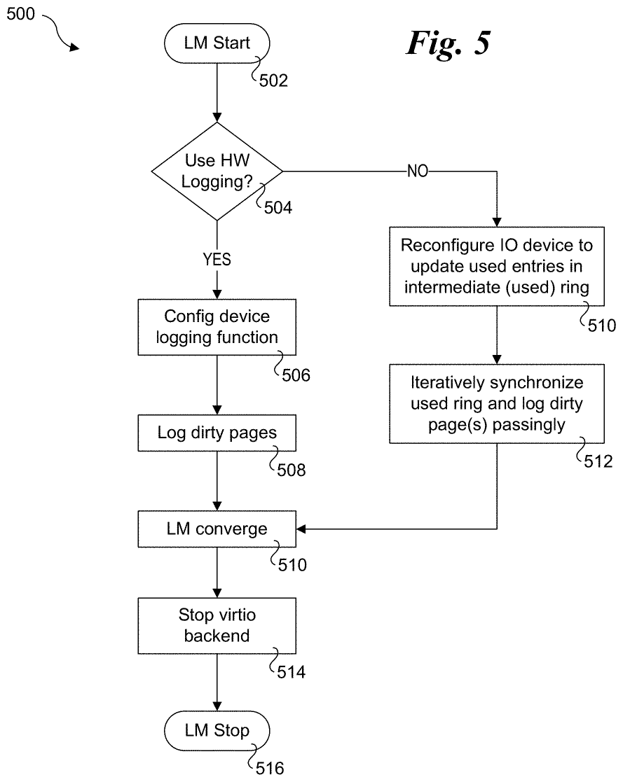

In the VDPA direct IO mode of architecture 200, virtio accelerator 208 interacts with the guest virtio driver 204 directly using Vring DMA block 214 to write entries to the descriptor ring 300, and used ring 304 of virtio ring 210 and to write packet data into buffers pointed to by the descriptors (see FIG. 4 below). During live migration, logging block 216 is activated and logs every page change as a result of device DMA writes to those pages. The dirty pages are marked in dirty page bitmap 212.

Architecture 202 includes a guest virtio driver 218 in the Guest layer, a QEMU VMM 219 and VDPA block 220 in the Host layer, and a virtio accelerator 222 in the HW layer. Guest virtio driver 218 includes a virtio ring 224, while VDPA block 220 includes a software relay 226 with an “intermediate” virtio ring 228 implementing a used ring and a dirty page bitmap 230. Virtio accelerator 208 includes a Vring DMA block 232, but does not perform hardware logging and thus does not include a logging block.

Under architecture 202, virtio accelerator 222 interacts with the guest virtio driver 218 directly using Vring DMA block 232 to write descriptor entries (descriptors) to descriptor ring 300 of virtio ring 224 and to write packet data into buffers pointed to by the descriptors. However, rather than directly writing entries to used ring 304, Vring DMA 232 writes entries to the used ring of Vring 228 in SW relay 226. SW relay 226, which operates as an intermediate relay component, is a virtual relay implemented in memory and via execution of software that is used to relay messages and/or data, as described below. Dirty page logging is done passingly during the relay operation performed by SW relay 226, with the dirty pages being marked in dirty page bitmap 230. SW relay also synchronizes updated entries in the used ring in Vring 228 with used ring 304, as described below in further detail. Since this IO model consumes some CPU resource to implement the SW relay operation, it is designed to run only during live migration stage, and there is a switchover from direct IO mode to this SW relay mode when live migration happens. Otherwise, outside of live migration the direct communication configuration of architecture 200 will be used.

Preferably, SW relay 226 should be implemented so as not to noticeably decrease virtio throughput during the live migration stage. In one embodiment, there is no buffer copy in the SW relay, so the SW relay operation is different from the traditional vhost SW implementation.

FIG. 4 shows an architecture 202a depicting further details of architecture 202. Vring 224 of Virtio driver 218 is further depicted as including a descriptor ring 402 with a plurality of descriptor entries 403, an available ring 404 with a plurality of available entries 405, and a used ring 406 including a plurality of used entries 407. Each descriptor entry 403 (also simply referred to as a descriptor) includes information describing a respective buffer 408 (such as a pointer to the buffer). Vring 228 of VDPA 220 is further depicted as including a used ring 410 having a plurality of used entries 412. Meanwhile, the descriptor and available rings of Vring 228 are shown as grayed-out and in phantom outline to indicate these are not used. For example, in one embodiment the same Vring data structure and API provided by the virtio library are used for Vring 224 and Vring 228, with the descriptor ring and available rings not being used for Vring 228. Used ring 410 is also not visible to virtio driver 218 (virtio driver 218 is not aware of the used ring's existence). Architecture 202a further shows an IOMMU 414 and a HW IO device 416 implemented in the HW layer.

To configure and implement live migration, VDPA 220 re-configures HW IO device 418 to write used entries to the intermediate virtio ring (i.e., used ring 410 of Vring 228) rather than used ring 407; Under this configuration, HW IO device 418 still accesses the original descriptor ring 402 and buffers 408 directly without any software interception; however, when a task is done (e.g., a packet is written into buffers pointed by a descriptor), HW IO device 416 updates a used ring entry 412 in used ring 410 in the intermediate Vring 228. Then, SW relay 226 is responsible for synchronizing this update to used ring 410 with an update to a corresponding entry 407 in used ring 406 in the guest Vring 224. During this used ring update, SW relay 226 parses the associated descriptors, if the buffer described by the descriptor has been written to by HW IO device 416, then SW relay 226 logs the written to pages in dirty page bitmap 230 allocated by the VMM (e.g., QEMU 219 in FIG. 4). This enables pages that have been modified by writes from the HW IO device to be tracked by the VMM. In one embodiment, logging is implemented in accordance with the following pseudocode,

page = addr / 4096;
log_base[page / 8] |= 1 << (page % 8);

where addr is the physical address of the page. Other logging schemes may also be used in a similar manner.

As an example, processing Packet n includes the following operations. First, HW IO device 418 will write the packet data for Packet n in a buffer 408a and add a descriptor 403 to descriptor ring 402 that describes buffer 408a (such as a pointer). Both the packet data and descriptor are written into Guest memory using DMA (e.g., via Vring DMA block 232). Upon receiving an update to an entry 412 in used ring 410, SW relay 226 parses the corresponding descriptor indexed by the used.id, and finds out the buffer address and length of the corresponding packet buffer 408a. With this information, SW relay 226 can set a corresponding bit in dirty page bitmap 230 to mark the page (in the guest memory being written to) as dirty; in cases where the buffer spans multiple memory pages each of those pages is marked as dirty. After finishing these parsing and page logging operations, SW relay 226 then updates a corresponding used entry 407 in used ring 406 in the guest to synchronize the entries in used rings 410 and 406.

Generally, a SW relay can be implemented with a polling thread, for better throughput; or it can run periodically to reduce CPU usage. In addition, an interrupt-based relay implementation may be used, which is a good alternative since it consumes little or no CPU resource when there is no traffic. The best mechanism (among the foregoing) for the SW relay will usually depend on the requirements of a given deployment.

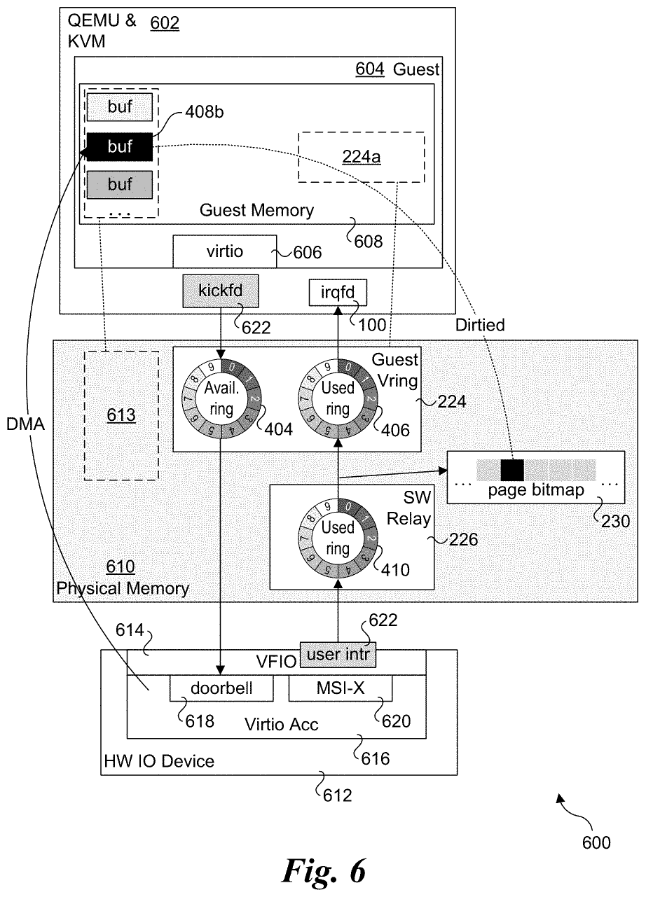

FIG. 5 shows a flowchart 500 illustrating the basic workflow for VDPA SW-assisted live migration of a running VM, according to one embodiment, which begins in a start block 502. In a decision block 504 a determination is made to whether hardware-based dirty page logging is supported. For example, the VDPA device driver can detect if the HW IO device supports HW dirty page logging. If the answer to decision block 504 is YES, the logic proceeds to a block 506 in which the HW IO device is configured for dirty page logging, and the performs logging of dirty pages in a block 508 until live migration reaches convergence in a block 510. If the answer to decision block 504 is NO, the HW IO device is reconfigured to update used entries in the intermediate (used) ring in a block 510 and starts to iteratively synchronize the used ring from the intermediate ring to the guest ring, as depicted in a block 512. During this synchronization, the relay SW assists in logging dirty pages on behalf of the HW IO device. Subsequently after some period of time, live migration converges (in block 510) and the VMM stops virtio backend in a block 514 and suspends the source VM to complete live migration in an end block 516.

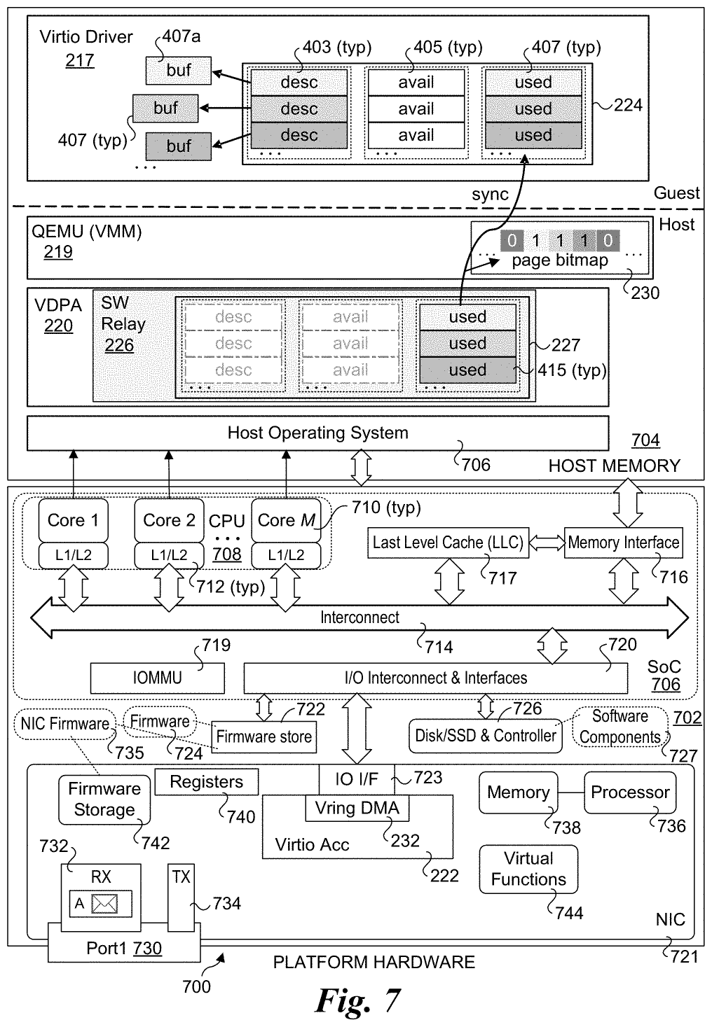

FIG. 6 shows a diagram 600 illustrating and event driven relay operation. The software components include QEMU and KVM (kernel virtual machine) 602 used to host a guest 604 including a virtio block 606 and having access to guest memory 608. As shown, available ring 404 and used ring 406 are implemented in guest memory 608, which is a portion of physical memory 610 allocated by the VMM (e.g., QEMU) to guest 604. As further illustrated, used ring 410 and dirty page bitmap 320 are also implemented in physical memory 610. In addition to physical memory 610, the hardware components include a HW IO device 612, including a virtual function IO (VFIO) interface 614 coupled to a virtio accelerator 616 including a doorbell 618, and MSI-X (message signal interrupt) block 620.

The event driven relay operation begins with a kickoff of a file descriptor (kickfd 622) that accesses an entry (or multiple entries) in available ring 404 of guest Vring 224 and forwards the entry or entries describing a task to be performed by HW IO device 612 via a DMA write to virtual accelerator 616 and rings doorbell 618 to inform virtio accelerator 616 of the available ring entry or entries. Each available ring entry identifies a location (buffer index) of an available buffer in guest memory to which HW IO device 612 may write packet data.

Subsequently, HW IO device 612 writes packet data into one or more of the available buffers in guest memory 608 using one or more DMA writes. In the example of FIG. 6, packet data has been DMA'ed into a buffer 408b. The DMA operation(s) will actually write the packet data to a buffer in a portion of physical memory 613 that has been allocated as virtual memory to guest 604. Upon filling the buffer, HW IO device 612 will update a corresponding entry in used ring 410 to indicate the buffer has been used and notify SW relay 226 by asserting a user interrupt 622 comprising an MSI-X interrupt. SW relay 226 will process the updated used ring entry to identify the memory page(s) that has been dirtied (written to) and mark that page/pages as dirtied in dirty page bitmap 230. The updated entry in used ring 410 will be synchronized with a corresponding entry in used ring 406, and the guest virtio ring will issue an irqfd 624 to inform guest 604 that a task has been completed. (irqfd is a mechanism in KVM that creates an eventfd-based file descriptor to inject interrupts to a guest.)

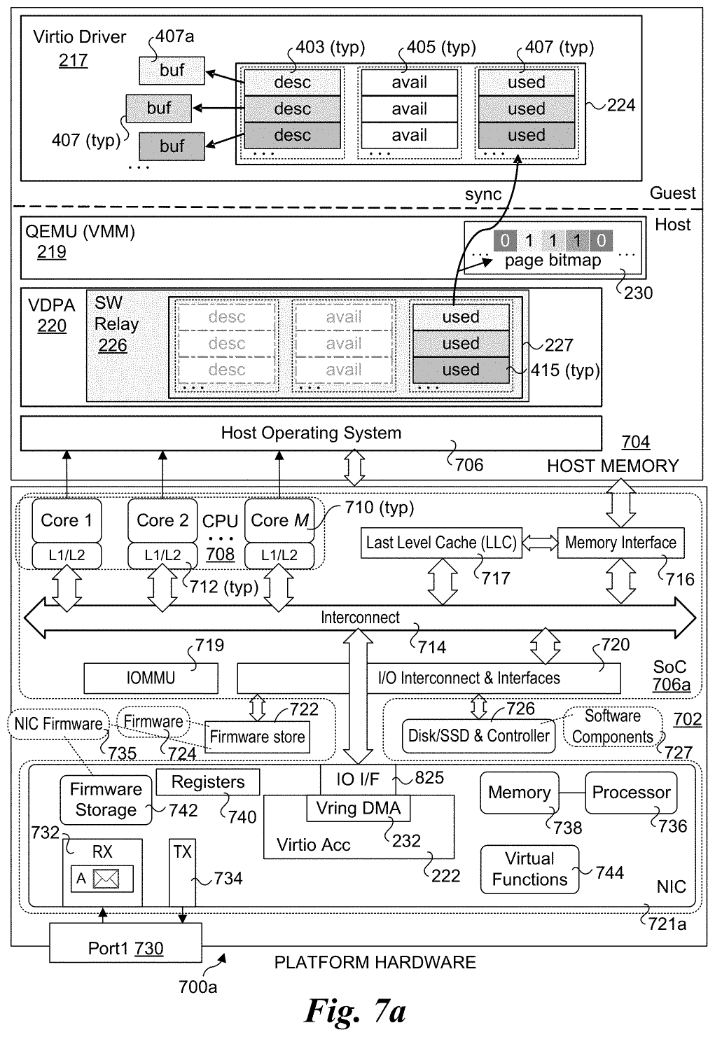

FIG. 7 shows one embodiment of a platform architecture 700 corresponding to a computing or host platform suitable for implementing aspects of the embodiments described herein. Architecture 700 includes a hardware layer in the lower portion of the diagram including platform hardware 702, and a software layer that includes software components running in host memory 704 including a host operating system 706.

Platform hardware 702 includes a processor 706 having a System on a Chip (SoC) architecture including a central processing unit (CPU) 708 with M processor cores 710, each coupled to a Level 1 and Level 2 (L1/L2) cache 712. Each of the processor cores and L1/L2 caches are connected to an interconnect 714 to which each of a memory interface 716 and a Last Level Cache (LLC) 718 is coupled, forming a coherent memory domain. Memory interface is used to access host memory 704 in which various software components are loaded and run via execution of associated software instructions on processor cores 710.

Processor 706 further includes an IOMMU 719 and an IO interconnect hierarchy, which includes one or more levels of interconnect circuitry and interfaces that are collectively depicted as IO interconnect & interfaces 720 for simplicity. In one embodiment, the IO interconnect hierarchy includes a PCIe root controller and one or more PCIe root ports having PCIe interfaces. Various components and peripheral devices are coupled to processor 706 via respective interfaces (not all separately shown), including a NIC 721 via an IO interface 723, a firmware storage device 722 in which firmware 724 is stored, and a disk drive or solid state disk (SSD) with controller 726 in which software components 728 are stored. Optionally, all or a portion of the software components used to implement the software aspects of embodiments herein may be loaded over a network (not shown) accessed, e.g., by NIC 721. In one embodiment, firmware 724 comprises a BIOS (Basic Input Output System) portion and additional firmware components configured in accordance with the Universal Extensible Firmware Interface (UEFI) architecture.

During platform initialization, various portions of firmware 724 (not separately shown) are loaded into host memory 704, along with various software components. In addition to host operating system 706 the software components include the same software components shown in architecture 202a of FIG. 4. Moreover, other software components may be implemented, such as various components or modules associated with a VMM or hypervisor, VMs, and applications running in the guest OS. Generally, a host platform may host multiple VMs and perform live migration of those multiple VMs in a similar manner described herein for live migration of a VM.

NIC 721 includes one or more network ports 730, with each network port having an associated receive (RX) queue 732 and transmit (TX) queue 734. NIC 721 includes circuitry for implementing various functionality supported by the NIC. For example, in some embodiments the circuitry may include various types of embedded logic implemented with fixed or programmed circuitry, such as application specific integrated circuits (ASICs) and Field Programmable Gate Arrays (FPGAs) and cryptographic accelerators (not shown). NIC 721 may implement various functionality via execution of NIC firmware 735 or otherwise embedded instructions on a processor 736 coupled to memory 738. One or more regions of memory 738 may be configured as MMIO memory. NIC further includes registers 740, firmware storage 742, Vring DMA block 232, virtio accelerator 222, and one or more virtual functions 744. Generally, NIC firmware 735 may be stored on-board MC 721, such as in firmware storage device 742, or loaded from another firmware storage device on the platform external to NIC 721 during pre-boot, such as from firmware store 722.

FIG. 7a shows a platform architecture 700a including an SoC 706a having an integrated NIC 721a configured in a similar manner to NIC 721 in platform architecture 700, with the following differences. Since NIC 721a is integrated in the SoC it includes an internal interface 725 coupled to interconnect 714 or another interconnect level in an interconnect hierarchy (not shown). RX buffer 732 and TX buffer 732 are integrated on SoC 706a and are connected via wiring to port 730a, which is a physical port having an external interface. In one embodiment, SoC 706a further includes IO interconnect and interfaces and platform hardware includes firmware, a firmware store, disk/SSD and controller and software components similar to those shown in platform architecture 700.

The CPUs 708 in SoCs 706 and 706a may employ any suitable processor architecture in current use or developed in the future. In one embodiment, the processor architecture is an Intel® architecture (IA), including but not limited to an Intel® x86 architecture, and IA-32 architecture and an IA-64 architecture. In one embodiment, the processor architecture is an ARM®-based architecture.

In addition to being implemented using PV-based VMs, embodiments may be implemented using hardware virtual machines (HVMs). HVMs are used by Amazon Web Services (AWS) and Amazon Elastic Compute Cloud (EC2) using Amazon Machine Images (AMI). The main differences between PV and HVM AMIs are the way in which they boot and whether they can take advantage of special hardware extensions (e.g. CPU, network, and storage) for better performance.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

As discussed above, various aspects of the embodiments herein may be facilitated by corresponding software and/or firmware components and applications, such as software and/or firmware executed by general-purpose processors, special-purpose processors and embedded processors or the like. Thus, embodiments of this invention may be used as or to support a software program, software modules, firmware, and/or distributed software executed upon some form of processor, processing core or embedded logic or a virtual machine running on a processor or core or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

Italicized letters, such as ‘n, M’, etc. in the foregoing detailed description are used to depict an integer number, and the use of a particular letter is not limited to particular embodiments. Moreover, the same letter may be used in separate claims to represent separate integer numbers, or different letters may be used. In addition, use of a particular letter in the detailed description may or may not match the letter used in a claim that pertains to the same subject matter in the detailed description.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method for performing live migration of a virtual machine (VM) including a guest operating system (OS) hosted by a virtual machine manager (VMM) or hypervisor on a compute platform including a processor on which software is executed and communicatively coupled to a hardware (HW) input/output (IO) device, comprising:
setting up a relayed data path between the HW IO device and a guest IO device driver in the guest OS, the relayed data path including an intermediate relay component;
implementing a direct memory access (DMA) datapath to enable the HW IO device to directly write data into guest memory in the VM; and
during live migration of the VM, using the intermediate relay component to track memory pages in guest memory being written to by the HW IO device using the DMA data path as dirty memory pages.

2. The method of claim 1, further comprising implementing the HW IO device as a para-virtualized IO device with hardware acceleration, wherein the HW IO device is enabled to directly write data into guest memory using the DMA data path.

3. The method of claim 2, wherein the para-virtualized IO device is implemented using a vhost data path acceleration (VDPA) component in a host layer, and wherein the intermediate relay component is a software (SW) relay implemented by the VDPA component.

4. The method of claim 3, wherein the VMM or hypervisor is implemented in the host layer and the dirty pages are logged to a data structure implemented by the VMM or hypervisor.

5. The method of claim 1, further comprising:
implementing an intermediate ring accessed by the intermediate relay component, the intermediate ring including a used ring;
updating, via the HW IO device, an entry in the used ring of the intermediate ring in conjunction with writing data to a buffer in guest memory;
processing the entry that is updated to determine a memory page containing the buffer; and
writing indicia associated with the memory page to indicate the memory page is dirty.

6. The method of claim 5, further comprising implementing a dirty page bitmap, wherein writing indicia associated with the memory page to indicate the memory page is dirty comprises marking a bit associated with the memory page that is dirty in the dirty page bitmap.

7. The method of claim 5, wherein the relayed data path is between the HW IO device and a guest IO device driver comprising a virtio device driver that implements a guest virtio ring including a descriptor ring, available ring, and used ring, further comprising:
configuring the IO HW device to update entries in the used ring of the intermediate ring; and
synchronizing entries in the used ring of the intermediate ring that have been updated with corresponding entries in the used ring in the guest virtio ring.

8. The method of claim 1, wherein the intermediate relay component is implemented as a polling thread executed on the processor.

9. The method of claim 1, wherein the intermediate relay component does not employ a buffer copy.

10. The method of claim 1, wherein the HW IO device comprises one of a Network Interface Controller (NIC), network interface, or network adaptor.

11. A non-transitory machine-readable medium having instructions stored thereon configured to be executed on a processor of a host platform including a hardware (HW) Input/Output (TO) device to facilitate live migration of a virtual machine (VM) including a guest operating system (OS) hosted by a virtual machine manager (VMM) or hypervisor running on the host platform in a host layer, wherein execution of the instruction enables the host platform to:
implement the HW TO device as a para-virtualized TO device with hardware acceleration, wherein the HW TO device is enabled to directly write data into guest memory using a direct memory access (DMA) data path;
set up a relayed data path between a between the HW TO device and a guest TO device driver in the guest OS, the relayed data path including a software (SW) relay; and
use the SW relay to track memory pages in guest memory being written to by the HW TO device using the DMA data path during live migration of the VM and log the memory pages being written to as dirty memory pages.

12. The non-transitory machine-readable medium of claim 11, wherein execution of the instructions further enables the host platform to:
implement a descriptor ring, available ring, and used ring in guest memory;
implement an intermediate ring accessed by the SW relay in the host layer, the intermediate ring including a used ring;
process an entry in the used ring of the intermediate ring that has been updated by the HW TO device in conjunction with writing data to a buffer in guest memory to determine a memory page containing the buffer; and
write indicia associated with the memory page to log the memory page as dirty.

13. The non-transitory machine-readable medium of claim 12, wherein execution of the instructions further enables the host platform to implement a dirty page bitmap, wherein writing indicia associated with the memory page to indicate the memory page is dirty comprises marking a bit associated with the memory page that is dirty in the dirty page bitmap.

14. The non-transitory machine-readable medium of claim 12, wherein the guest TO device driver is a virtio device driver that implements a guest virtio ring (Vring) including the descriptor ring, available ring, and used ring, wherein execution of the instructions further enables the host platform to:
implement a Vring direct memory access (DMA) block on the HW IO device, the Vring DMA block configured to update entries on the descriptor ring via a DMA data path;
configure the Vring DMA block to update entries in the used ring of the intermediate ring; and
synchronize entries in the used ring of the intermediate ring that have been updated with corresponding entries in the used ring in the guest virtio ring.

15. The non-transitory machine-readable medium of claim 11, wherein execution of the instructions further enables the host platform to:
determining whether the HW IO device supports hardware logging of dirty pages; and
if the hardware device does not support hardware logging of dirty pages, implementing the SW relay to log dirty pages.

16. The non-transitory machine-readable medium of claim 11, wherein the para-virtualized IO device with hardware acceleration is implemented using a vhost data path acceleration (VDPA) component in the host layer comprising a portion of the instructions, and wherein the SW relay is implemented by the VDPA component.

17. The non-transitory machine-readable medium of claim 16, wherein the dirty pages are logged by the SW relay to a data structure implemented by the VMM or hypervisor.

18. The non-transitory machine-readable medium of claim 11, wherein a portion of the instructions comprise a SW relay polling thread.

19. The non-transitory machine-readable medium of claim 11, wherein the HW IO device comprises a one of a Network Interface Controller (NIC), network interface, or network adaptor.

20. A compute platform, comprising:
a processor, having a plurality of cores and an Input/Output (TO) interface;
memory, communicatively coupled to the processor;
a hardware (HW) IO device, including a HW accelerator, communicatively coupled to the IO interface;
a storage device, communicatively coupled to the processor; and
a plurality of instructions stored in at least one of the storage device and memory and configured to be executed on at least a portion of the plurality of cores, the plurality of instructions including instructions associated with a plurality of software components comprising a virtual machine manager (VMM) or hypervisor and a virtual machine (VM) on which a guest operating system (OS) is run that is hosted by the VMM or hypervisor, wherein execution of the plurality of instructions enables the compute platform to:
implement the HW IO device as a para-virtualized IO device with hardware acceleration, wherein the HW IO device is enabled to directly write data into guest memory using a direct memory access (DMA) data path and the HW accelerator;
configure a relayed data path from the HW IO device to a guest IO device driver in the guest OS, the relayed data path including a software (SW) relay; and
perform a live migration of the VM during which,
the HW IO device writes data to one or more buffers in the guest memory using the DMA data path; and
the SW relay tracks memory pages in guest memory being written to by the HW IO device and logs the memory pages being written to as dirty memory pages.

21. The compute platform of claim 20, wherein the VMM or hypervisor is implemented in a host layer and execution of the instructions further enables the compute platform to:
implement a descriptor ring, available ring, and used ring in guest memory;
implement an intermediate ring accessed by the SW relay in the host layer, the intermediate ring including a used ring;
update, via the HW IO device, an entry in the used ring of the intermediate ring, the entry that is updated being associated with data having been written to the guest memory by the HW IO device via the DMA data path;
process the entry in the used ring of the intermediate ring that has been updated to determine a memory page containing the buffer; and
write indicia associated with the memory page to log the memory page is dirty.

22. The compute platform of claim 21, wherein the guest IO device driver is a virtio device driver that implements a guest virtio ring (Vring) including the descriptor ring, available ring, and used ring, wherein execution of the instructions further enables the compute platform to:
implement a Vring direct memory access (DMA) block on the HW IO device, the Vring DMA block configured to update entries on the descriptor ring via a DMA data path;
configure the Vring DMA block to update entries in the used ring of the intermediate ring; and
synchronize entries in the used ring of the intermediate ring that have been updated with corresponding entries in the used ring in the guest virtio ring.

23. The compute platform of claim 20, wherein the para-virtualized IO device with hardware acceleration is implemented using a vhost data path acceleration (VDPA) component comprising a portion of the plurality of instructions, and wherein the SW relay is implemented by the VDPA component.

24. The compute platform of claim 23, wherein the dirty pages are logged by the SW relay to a data structure implemented by the VMM or hypervisor.

25. The compute platform of claim 20, wherein the HW IO device comprises a one of a Network Interface Controller (NIC), network interface, or network adaptor.
